(19) United States
(12) Patent Application Publication
(10) Pub. No.: US 2025/0141834 A1
(43) Pub. Date: May 1, 2025

(54) AUTOMATIC ADDRESS ASSIGNMENT

(71) Applicant: Infineon Technologies AG, Neubiberg (DE)

(72) Inventors: Martin Barth, Passau (DE); Markus Matzberger, Tiefenbach (DE); Tobias Otter, Unterhaching (DE)

(21) Appl. No.: 18/886,745

(22) Filed: Sep. 16, 2024

(30) Foreign Application Priority Data
Oct. 26, 2023 (DE) 102023210620.5

(51) Int. Cl. H04L 61/50

(52) U.S. Cl. CPC H04L 61/50

(57) ABSTRACT

A method for assigning an address to an electronic device is described. The method may comprise starting a test system for performing a test of a circuit arrangement comprising the electronic device, and implementing a communication protocol between the circuit arrangement and the test system. The method may also comprise reading out a predetermined unique identifier (UID) of the electronic device by using the test system, assigning the UID to at least one property of the electronic device within a lookup table, wherein the property is determined by using the test system, and assigning an address to the electronic device by using the lookup table.

### TECHNICAL FIELD

The present disclosure relates to a method for assigning an address to an electronic device, an electronic device, a circuit arrangement, a test system and a use thereof.

### BACKGROUND

Groups of electronic devices and specifically networks typically require addresses for the electronic devices in order to enable communication. When assigning an address to an electronic device, interference with an address of a further electronic device should be avoided for clarity reasons. This can specifically be problematic for electronic devices of the same type. Thus, pre-defined address ranges may typically be required. Further, assigning such addresses typically requires additional connected passive components for address selection.

### SUMMARY

In a first aspect, a method for assigning an address to an electronic device is presented. The method comprises:
a) starting a test system for performing a test of a circuit arrangement comprising the electronic device;
b) implementing a communication protocol between the circuit arrangement and the test system;
c) reading out a predetermined unique identifier (UID) of the electronic device by using the test system;
d) assigning the UID to at least one property of the electronic device within a lookup table, wherein the property is determined by using the test system; and
e) assigning an address to the electronic device by using the lookup table.

In a further aspect, an electronic device is presented. The electronic device has an address assigned by using at least the following steps:
a) starting a test system for performing a test of a circuit arrangement comprising the electronic device;
b) implementing a communication protocol between the circuit arrangement and the test system;
c) reading out a predetermined unique identifier (UID) of the electronic device by using the test system;
d) assigning the UID to at least one property of the electronic device within a lookup table, wherein the property is determined by using the test system; and
e) assigning an address to the electronic device by using the lookup table.

In a further aspect, a circuit arrangement is presented. The circuit arrangement comprises at least one electronic device and at least one interface. The electronic device has an address assigned by using at least the following steps:
a) starting a test system for performing a test of a circuit arrangement comprising the electronic device;
b) implementing a communication protocol between the circuit arrangement and the test system;
c) reading out a predetermined unique identifier (UID) of the electronic device by using the test system;
d) assigning the UID to at least one property of the electronic device within a lookup table, wherein the property is determined by using the test system; and
e) assigning an address to the electronic device by using the lookup table.

In a further aspect, a test system is presented. The test system is configured for performing a test of at least one circuit arrangement. The circuit arrangement comprises at least one electronic device and at least one interface. The test system is further configured for reading out a predetermined unique identifier (UID) of the electronic device. The test system is further configured for determining at least one property of the electronic device.

In a further aspect, a use of at least one of the method, the electronic device, the circuit arrangement and the test system is presented. The purpose of use is an automotive application.

Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates an exemplary embodiment of a circuit arrangement in interaction with a test system according to the present disclosure in a schematic fashion;

FIG. 2 illustrates a flow chart of an exemplary embodiment of a method for assigning an address to an electronic device according to the present disclosure; and

FIG. 3 illustrates a diagram of an exemplary embodiment of a specific procedure for the address assignment.

### DETAILED DESCRIPTION

In a first aspect, a method for assigning an address to an electronic device is presented. The term “electronic device” as generally used herein is a broad term and is to be given its ordinary and customary meaning to a person of ordinary skill in the art and is not to be limited to a special or customized meaning. The electronic device may be a device using electrical energy during operation. The electronic device may be or may comprise at least one electronic circuit.

The electronic device may comprise at least one electronic component. The electronic component may be connected to at least one further electronic component. Thus, the electronic device may be an assembly of at least two electronic components, which are at least partially interconnected through conductive elements. As an example, the electronic components may comprise resistors, inductors, capacitors, diodes and/or transistors and/or assemblies thereof such as logic gates and/or processors. As an example, the conductive elements may comprise wires and/or traces.

Specifically, the electronic device may be or may comprise at least one integrated circuit. Thus, the electronic device or at least a part of the electronic device may be arranged on at least one piece of semiconductor material, specifically silicon, silicon carbide and/or gallium nitride. Thus, the electronic device may be or may comprise at least one semiconductor device. The semiconductor device may be a device comprising at least one semiconductor material, specifically silicon, silicon carbide and/or gallium nitride. Specifically, the electronic device may be network compatible. Thus, the electronic device may be configured for communicating with at least one further electronic device. The electronic device may be configured for interpreting and/or following at least one communication protocol. The electronic device may comprise at least one input/output module for sending and/or receiving data. As will be outlined in further detail below, the electronic device may comprise at least one pin.

The term “address” as generally used herein is a broad term and is to be given its ordinary and customary meaning to a person of ordinary skill in the art and is not to be limited to a special or customized meaning. The address may be an identifier or a tag configured for identifying the electronic device within a group of electronic devices. Specifically, the electronic device may be a part of a network. The address may be a network address. The network may be an at least partially interconnected group of electronic devices of identical or of different type. The address may be configured for controlling or directing a data transfer between electronic devices. Thus, the address may be configured for identifying a source and/or a destination of a data package which is transferred.

The term “assigning”, including grammatical variations thereof, as generally used herein is a broad term and is to be given its ordinary and customary meaning to a person of ordinary skill in the art and is not to be limited to a special or customized meaning. The assigning may be an act of allocating or designating a first entity to a second entity, in this case an address to an electronic device. The assigning may be an act of linking or connecting the first entity and the second entity, in this case the address and the electronic device. Thus, the address and the electronic device may be associated with each other after the assignment. Assigning an address to the electronic device may enable the electronic device to communicate with other electronic devices, specifically within a network. Specifically, assigning an address to the electronic device may enable other electronic devices to address the electronic device such as when sending a data package.

In a step a), the method comprises starting a test system for performing a test of a circuit arrangement comprising the electronic device. The term “circuit arrangement” as generally used herein is a broad term and is to be given its ordinary and customary meaning to a person of ordinary skill in the art and is not to be limited to a special or customized meaning. The circuit arrangement may be or may comprise at least one electronic circuit, specifically at least one integrated circuit. Specifically, the circuit arrangement may comprise a plurality of electronic circuits. Thus, the circuit arrangement may also comprise a plurality of electronic devices. The electronic devices may at least partially be interconnected. Thus, the circuit arrangement may be an assembly of at least two electronic devices, which are at least partially be interconnected through conductive elements.

The circuit arrangement may be or may comprises at least one printed circuit board (PCB). The term “printed circuit board”, in short “PCB”, as generally used herein is a broad term and is to be given its ordinary and customary meaning to a person of ordinary skill in the art and is not to be limited to a special or customized meaning. The PCB may be or may comprise a carrier or a support for at least one electronic component or an electronic device. The PCB may comprise a flat board configured for supporting and/or connecting electronic components or electronic devices. Thus, the PCB may comprise at least one insulating material such as plastics and/or at least one conducting material such as a metal. The conducting material May be patterned on the insulating material for forming a circuit arrangement or at least a part thereof, specifically at least connections between electronic components or electronic devices. Thus, the PCB may comprise a plurality of traces or at least one trace.

The term “test” as generally used herein is a broad term and is to be given its ordinary and customary meaning to a person of ordinary skill in the art and is not to be limited to a special or customized meaning. A test may be or may comprise an act of evaluating or analyzing a performance or a quality of an entity such as of a circuit arrangement or of an electronic device. Thus, the test may be configured for identifying or determining whether the circuit arrangement works correctly. The test of the circuit arrangement may be performed for sorting out faulty circuit arrangements. The test of the circuit arrangement may be performed for identifying and/or resolving a problem in a circuit arrangement such as a faulty electronic device which may be replaced or repaired. Thus, the test may also be configured for identifying or determining which parts of the circuit arrangement may work correctly and which parts of the circuit arrangement may not work correctly. The test may be configured for measuring and/or determining electronic parameters such as resistance, capacity or inductivity for identifying defects, e.g. by using an electrical probe.

As said, the circuit arrangement may comprise at least one PCB. Thus, the test may specifically be or may comprise an in-circuit testing (ICT). Thus, the test system may be or may comprise an ICT system. The term “in-circuit testing”, in short “ICT”, as generally used herein is a broad term and is to be given its ordinary and customary meaning to a person of ordinary skill in the art and is not to be limited to a special or customized meaning. The ICT may be or may comprise a test of a PCB, specifically of the electronic devices of the PCB and/or the connections between the electronic devices. In the ICT, an electrical probe may test the PCB for quantities, such as shorts or opens, which can show whether the PCB is assembled correctly. The ICT may be performed by using an adapter, specifically a needle adapter, for contacting the PCB.

The term “system” as generally used herein is a broad term and is to be given its ordinary and customary meaning to a person of ordinary skill in the art and is not to be limited to a special or customized meaning. The system may be an arbitrary set of interacting or interdependent entities or components forming a whole. Specifically, the components may interact with each other in order to fulfill at least one common function. The components may be handled independently or may be coupled or connectable. The term “test system” as generally used herein is a broad term and is to be given its ordinary and customary meaning to a person of ordinary skill in the art and is not to be limited to a special or customized meaning. The test system may be a system configured for testing an entity, such as a circuit arrangement, wherein reference may specifically be made to the definitions of the terms “test” and “system” above. As said, the test system may specifically be or may comprise an ICT system. The term “in-circuit testing system”, in short “ICT system”, as generally used herein is a broad term and is to be given its ordinary and customary meaning to a person of ordinary skill in the art and is not to be limited to a special or customized meaning. The ICT system may be a system for performing an ICT of a PCB, wherein reference may specifically be made to the definitions of the terms “ICT” and “PCB” above. Testing the circuit arrangement, specifically the PCB, may be typically be required before using it. Thus, the test system, specifically the ICT system, may be required anyway before putting the circuit arrangement in operation. Therefore, by additionally using the test system for address assignment, a use of further specific passive components for address assignment may be avoided.

Step a) may further comprise connecting the test system with an interface of the circuit arrangement by using an adapter of the test system. The adapter may specifically be a needle adapter. Still further, step a) may comprise contacting a pin of the electronic device by using the adapter, specifically the needle adapter. The term “interface” as generally used herein is a broad term and is to be given its ordinary and customary meaning to a person of ordinary skill in the art and is not to be limited to a special or customized meaning. The interface may be a boundary across which two or more entities may transmit information such as a data package. The interface may be a physical interface and/or a logical interface. Specifically, the interface of the circuit arrangement may allow a communication between the circuit arrangement and the test system. More specifically, the interface may allow a communication of an electronic device with the test system. Further, the interface may allow a communication of components of the circuit arrangement with each other, i.e. internally within the circuit arrangement. The interface may specifically be a serial interface. However, the interface may in principle also be a parallel interface. The interface may comprise at least one pin. The interface may comprise at least one bus, specifically at least one serial bus. The bus may comprise at least one pin. The bus may comprise at least one signal line, i.e. a conductive path. The signal line may specifically be a data line. More specifically, the bus may comprise a clock line and a data line. The data line may be used for transmitting a data package. The clock line may be used for synchronization. As an example, the bus may be an Inter-Integrated Circuit (I²C). However, other options may also be feasible.

The term “adapter” as generally used herein is a broad term and is to be given its ordinary and customary meaning to a person of ordinary skill in the art and is not to be limited to a special or customized meaning. The adapter may be a device configured for establishing an electrical connection to an object, such as a pin of an electrical device or of the circuit arrangement, specifically of a bus of the interface of the circuit arrangement. Specifically, the adapter may be configured for establishing an electrical connection between the electrical device and the test system and/or between the circuit arrangement and the test system. Thus, the test system may be enabled for electrically testing the electronic device and/or the circuit arrangement. As indicated, the adapter may specifically be a needle adapter. Thus, the adapter may comprise at least one needle, specifically a plurality of needles. A first needle may be brought in physical contact with a pin of an electronic device. A second needle may be brought in physical contact with a pin of the bus. Thus, the adapter may be connected to the interface of the circuit arrangement, more specifically to a bus of the interface, for enabling communication between the circuit arrangement and the test system.

In a step b), the method further comprises implementing a communication protocol between the circuit arrangement and the test system. The term “communication protocol” as generally used herein is a broad term and is to be given its ordinary and customary meaning to a person of ordinary skill in the art and is not to be limited to a special or customized meaning. The communication protocol may be or may comprise a set of rules and/or assignments allowing entities to transfer information such as a message or a data package to each other. The communication protocol may specifically determine at least one of a format, a syntax, a semantic, a synchronization and an error checking of messages exchanged between the entities. The entities may specifically comprise electronic devices, but also for instance the test system. The entities may all agree on the used communication protocol. Multiple communication protocols may be used in parallel for different purposes or in other words for different aspects or functions of a communication between entities. The communication protocols may be assigned to different layers such as layers defined in the Open Systems Interconnection model. Thus, the communication protocol may be a layered communication protocol and/or a standardized communication protocol. The communication protocol may be implemented in software and/or in hardware.

The term “implementing”, including arbitrary grammatical variations thereof, as generally used herein is a broad term and is to be given its ordinary and customary meaning to a person of ordinary skill in the art and is not to be limited to a special or customized meaning. The implementing may be an act of realizing something or establishing something or putting something into effect. Thus, the communication protocol may be implemented by programming software and/or hardware, e.g. by executing a software program in a processor or by hardware programming a field-programmable gate array. The communication protocol may be implemented by providing an infrastructure for communication such as a hardware infrastructure, e.g. at least one interface. Thus, the implementing may comprise providing an interface connecting the circuit arrangement with the test system and allowing the circuit arrangement to communicate with the test system. Further, the implementing may comprise aligning or coordinating the circuit arrangement and the system to use a common communication protocol for communication with each other. Thus, at least one shared communication protocol may be established in both the circuit arrangement and the test protocol.

In a step c), the method further comprises reading out a predetermined unique identifier (UID) of the electronic device by using the test system. The term “unique identifier”, in short “UID”, as generally used herein is a broad term and is to be given its ordinary and customary meaning to a person of ordinary skill in the art and is not to be limited to a special or customized meaning. The UID may be a tag or an indicator configured for clearly or distinctly identifying or tagging an entity, specifically an electronic device. In other words, the UID may specifically be an attribute of the electronic device configured for clearly distinguishing the electronic device from further electronic devices, specifically including further electronic devices of the same type. Thus, two or more electronic devices of the same type may have different UIDs. In other words, two or more electronic devices which are identical in design may have different UIDs. The UID may be programmed on a non-volatile memory of the electronic device. The UID may be hardware programmed on the electronic device. The UID may be derived from an assigned chip identifier (chip ID) by using a predetermined algorithm. The chip ID and/or the algorithm may be determined by a manufacturer of the electronic device.

In a step d), the method further comprises assigning the UID to at least one property of the electronic device within a lookup table. The property is determined by using the test system. The property may be a property other than the UID. In other words, the property may not be the UID or may be different to the UID. The property may be directly determined by using the test system. Specifically, the property of the electronic device may comprise a position of the electronic device in the circuit arrangement. Thus, step d) may specifically comprise assigning the UID to a position of the electronic device within a lookup table. More specifically, step d) may comprise assigning the UID to a position of the electronic device in the circuit arrangement within a lookup table. As an example, the test system may test the circuit arrangement by contacting the electronic devices comprised by the circuit arrangement. When contacting an electronic device in the circuit arrangement, the test system may also know or measure a position of the electronic device in the circuit arrangement. As indicated, in step c), the test system may read out the UID of the electronic device. Thus, the test system may know the UID and the position of the electronic device and can map the UID and the position in a lookup table for further processing. The test system may then store and/or forward the lookup table.

Additionally or alternatively, the property may be indirectly determined by using the test system. Specifically when considering predetermined mounting options on a PCB, from the position further properties may be derived, such as a type or a function of the electronic device, which can also be mapped with the UID. Thus, the property of the electronic device may comprise a function of the electronic device. Further, the property of the electronic device may comprise a type number of the electronic device. The type number may also be referred to as part number. Electronic devices of the same type or in other words electronic devices with identical design may have the same type number. However, as said, electronic devices of the same type may specifically still have a different ID. Further options for the property besides the position, the function or the type number may also be conceivable.

The term “lookup table” as generally used herein is a broad term and is to be given its ordinary and customary meaning to a person of ordinary skill in the art and is not to be limited to a special or customized meaning. The lookup table may be a data structure mapping at least two entities. Thus, the lookup table may comprise a plurality of data tuples, e.g. data pairs. Specifically, the lookup table may provide a link between the UID and at least one further property of the electronic device, such as a position and/or a function and/or a type number. The lookup table may be retrievable later on for further processing. The lookup table may be stored, e.g. in memory, or forwarded to further entities, e.g. to a processor for further processing. The lookup table may be implemented as an array. Thus, associated entities may be indexed with an identical index. Other options for implementing a lookup table are feasible and well known to the skilled person.

In a step e), the method further comprises assigning an address to the electronic device by using the lookup table. Specifically, step e) may comprise using at least one of the UID and the property of the electronic device determined by using the test system for assigning the address to the electronic device. Thus, step e) may specifically comprise using the UID for assigning the address to the electronic device. As said, the UID may clearly distinguish the electronic device from further electronic devices, specifically including further electronic devices of the same type. Thus, through the presented method it may be ensured that different electronic devices, although they may be of the same type, may also be assigned different addresses. The circuit arrangement may comprise a plurality of electronic devices. The method may comprise assigning an individual address to each electronic device of the circuit arrangement. At least two of the electronic devices may be of the same type. The method may comprise assigning the at least two electronic devices of the same type different addresses. In other words, the at least two electronic devices of the same type may be assigned different addresses. Thus, interference with an address of a further electronic device may be avoided and a clear assignment may be established for further communication. Further, pre-defined address ranges may also be avoided.

Throughout the present disclosure, the presented method steps may be performed in the indicated order. It shall be noted, however, that a different order may also be possible. The method may comprise further method steps which are not listed. Further, one or more of the method steps may be performed once or repeatedly. Further, two or more of the method steps may be performed simultaneously or in a timely overlapping fashion. Specifically, steps a) to c) may be performed during a test of the circuit arrangement. Step d) and/or step e) may also be performed during the test. Thus, at least one of step d) and step e) may at least partially be performed by using the test system. Further, at least one of step d) and step e) may be performed at an initial power-on of the circuit arrangement. In other words, step d) and/or step e) may be performed after the test and not by using the test system as will also be outlined below in further detail. The initial power-on of the circuit arrangement may be a first start of an operation of the circuit arrangement or a restart of the operation of the circuit arrangement.

The communication protocol may determine at least a set of addresses. The addresses may comprise already occupied addresses, i.e. addresses which cannot be assigned further, e.g. because they were already assigned to another entity such as another electronic device. The addresses may however specifically also comprise addresses which are still available and not already occupied. Thus, the set of addresses may comprise at least a set of available addresses. Step e) may comprise assigning at least one of the UID and the property of the electronic device determined by using the test system to an available address. Thus, step e) may comprise assigning the UID and/or the property of the electronic device, e.g. a position of the electronic device, to an available address. The addresses may be arranged in an address list, e.g. an array of addresses, wherein a first number of addresses may be available and a second number of addresses may be occupied. As an example, step e) may comprise assigning the UID and/or the property to a first available address in the address list, which may then be occupied afterwards. Thus, the next UID and/or property may be assigned to the next available address in the address list.

The communication protocol may further determine at least a set of commands for communication between the circuit arrangement and the test system. Additionally or alternatively, the communication protocol may determine a set of commands for communication within the circuit arrangement, such as a set of commands for communication between the electronic devices and a controller of the circuit arrangement. The set of commands may comprise at least one general command sent out to all electronic devices comprised by the circuit arrangement. The term “general command” as generally used herein is a broad term and is to be given its ordinary and customary meaning to a person of ordinary skill in the art and is not to be limited to a special or customized meaning. The general command may be an instruction which is sent out globally to all connected devices, e.g. to all network members. Thus, the general command may specifically not be sent only to a selected group of devices, which may require knowing their addresses before. The general command may not require an acknowledgement of a receiver of the general command.

The general command may be a general readout command or a general assign command. Other options may also be feasible. Further, the general command may trigger at least one arbitration. Step c) may comprise sending out a general readout command from the test system for sending the UID to the test system. The general assign command may be sent to all electronic devices of the circuit arrangement via the interface. Thus, the test system may ask all electronic devices to send their respective UIDs via the interface. Step e) may comprise sending out a general assign command from the test system. The general assign command may comprise the UID of the electronic device and the address assigned to the electronic device. The general assign command may be sent to all electronic devices of the circuit arrangement via the interface. Thus, each electronic device may recognize its own UID and accept the address sent with this UID. Step e) may further comprise acknowledging the assigned address by a handshake between the electronic device and the test system. Thus, the test system may be configured for assigning the address to the electronic device by using the lookup table.

Additionally or alternatively, the readout of the UID in step c) may be triggered by detecting a predetermined logical state of the electronic device with the test system. The logical state may be determined in the communication protocol. Specifically, the predetermined logical state may comprise a predetermined voltage applied to at least one pin of the electronic device. In other words, when the test system detects the predetermined voltage at the pin during the test of the circuit arrangement, the test system may read out the UID of the electronic device. The predetermined voltage may be an arbitrary voltage, e.g. a supply voltage or also 0 V. The predetermined voltage may also be a voltage interval, e.g. in order to cover voltage fluctuations in an electronic circuit. The predetermined voltage may further cause an electrical current. Thus, additionally or alternatively, when the test system detects an electrical current when contacting the pin during the test of the circuit arrangement, the test system may read out the UID of the electronic device.

The term “pin” as generally used herein is a broad term and is to be given its ordinary and customary meaning to a person of ordinary skill in the art and is not to be limited to a special or customized meaning. The pin may be an electrical contact of a device, such as of an electronic device or of the circuit arrangement, specifically of a bus of the interface of the circuit arrangement. The pin may be conductive and specifically comprise a metal accessible to an outside of the electronic device and/or the circuit arrangement. The pin may be configured for being contacted from at least one further entity outside of the electronic device and/or the circuit arrangement, specifically from the test system such as by using the needle adapter. Thus, the pin may enable an electrical connection and consequently a signal transfer between the electronic device and the test system. Additionally or alternatively, the pin may enable an electrical connection and consequently a signal transfer between the circuit arrangement and the test system.

The circuit arrangement may further comprise a controller. The term “controller” as generally used herein is a broad term and is to be given its ordinary and customary meaning to a person of ordinary skill in the art and is not to be limited to a special or customized meaning. The controller may be an entity configured for observing or regulating or operating or managing at least one further entity. The controller may be a computing device. The controller may be an electronic device. Thus, the controller may be or may comprise at least one electronic circuit, specifically an integrated circuit. The controller may comprise at least one processor, e.g. a central processing unit. The controller may further comprise at least one memory. The controller may comprise at least one peripheral, specifically an input/output module such as a Universal Asynchronous Receiver-Transmitter. The controller may specifically be microcontroller. The circuit arrangement may comprise a plurality of microcontrollers. The controller may specifically be a main microcontroller of the circuit arrangement or a central microcontroller of the circuit arrangement. However, a multi-master arrangement may also be feasible within the circuit arrangement.

At least one of step d) and step e) may at least partially be performed by using the controller, specifically the main microcontroller of the circuit arrangement. Specifically, in step d), assigning the UID to the property of the electronic device, e.g. the position of the electronic device, within a lookup table may be performed by using the controller. Thus, the lookup table may be provided to the controller for assigning the address to the electronic device. Specifically, the lookup table may be provided to the controller from the test system. Step e) may comprise sending out a general assign command from the controller. The general assign command may comprise the UID of the electronic device and the address assigned to the electronic device. The general assign command may be sent to all electronic devices of the circuit arrangement via the interface. Thus, each electronic device may recognize its own UID and accept the address sent with this UID. Step e) may further comprise acknowledging the assigned address by a handshake between the electronic device and the controller. Thus, the controller may be configured for assigning the address to the electronic device by using the lookup table.

The method may at least partially be computer implemented. The term “computer-implemented” as used herein is a broad term and is to be given its ordinary and customary meaning to a person of ordinary skill in the art and is not to be limited to a special or customized meaning. The term specifically may refer, without limitation, to a method involving at least one computing device, e.g. a microcontroller. As indicated, the computing device may comprise at least one processor which is configured for at least partially performing at least one of the method steps according to the present disclosure. The method steps may at least partially be performed automatically, specifically without user interaction. However, obviously, the presented method steps may at least partially also be performed with user interaction. As an example, a user may manually start a test system in step a). The test itself may also at least partially be controlled or guided by a user. Further, the assignments in step d) and e) may also in principle at least be assisted by a user.

In a further aspect, an electronic device is presented. The electronic device has an address assigned by using at least the following steps:
a) starting a test system for performing a test of a circuit arrangement comprising the electronic device;
b) implementing a communication protocol between the circuit arrangement and the test system;
c) reading out a predetermined unique identifier (UID) of the electronic device by using the test system;
d) assigning the UID to at least one property of the electronic device within a lookup table, wherein the property is determined by using the test system; and
e) assigning an address to the electronic device by using the lookup table.

The address may be assigned by using a method according to any one of the embodiments referring to method as disclosed above or below in further detail. As said, the electronic device may comprise at least one pin. The pin may be configured for being contacted by an adapter of the test system. Specifically, the pin may be configured for being contacted by a needle adapter of the test system. The electronic device may be network compatible. The electronic device may be a semiconductor device. The electronic device may comprise at least one electronic circuit, specifically at least one integrated circuit. For further definitions and embodiments regarding the electronic device reference may specifically also be made to the definitions and embodiments presented with respect to the method for assigning an address to the electronic device.

In a further aspect, a circuit arrangement is presented. The circuit arrangement comprises at least one electronic device and at least one interface. The electronic device has an address assigned by using at least the following steps:
a) starting a test system for performing a test of a circuit arrangement comprising the electronic device;
b) implementing a communication protocol between the circuit arrangement and the test system;
c) reading out a predetermined unique identifier (UID) of the electronic device by using the test system;
d) assigning the UID to at least one property of the electronic device within a lookup table, wherein the property is determined by using the test system; and
e) assigning an address to the electronic device by using the lookup table.

The address may be assigned by using a method according to any one of the embodiments referring to a method as disclosed above or below in further detail. The electronic device may be an electronic device according to any one of the embodiments referring to an electronic device as disclosed above or below in further detail. As said, the circuit arrangement may comprise at least one PCB. The interface may be a serial interface. The interface may comprise at least one bus, specifically at least one serial bus. The bus may comprise at least one signal line, specifically a data line. The bus may comprise a clock line and a data line. The bus may specifically be an I²C. The interface may be configured for being connected to an adapter of the test system, specifically to a needle adapter. Further, the electronic device may be connected to the interface of the circuit arrangement. As said, the electronic device may comprise at least one pin. The pin may be a part of the interface of the circuit arrangement. The circuit arrangement may further comprise at least one controller, specifically a main microcontroller. The controller may be connected to the interface of the circuit arrangement. The controller may be configured for assigning the address to the electronic device by using the lookup table. The controller may be configured for sending out a general assign command to the at least one electronic device of the circuit arrangement, such as for assigning the address to the electronic device. For further definitions and embodiments regarding the circuit arrangement reference may specifically also be made to the definitions and embodiments presented with respect to the method for assigning an address to the electronic device.

In a further aspect, a test system is presented. The test system is configured for performing a test of at least one circuit arrangement. The circuit arrangement comprises at least one electronic device and at least one interface. The test system is further configured for reading out a predetermined unique identifier (UID) of the electronic device. The test system is further configured for determining at least one property of the electronic device.

As already indicated, the property may be selected from the group consisting of: a position of the electronic device in the circuit arrangement; a function of the electronic device within the circuit arrangement; a type number of the electronic device. Further options may be feasible. The electronic device may be an electronic device according to any one of the embodiments referring to an electronic device as disclosed above or below in further detail. The circuit arrangement may be a circuit arrangement according to any one of the embodiments referring to a circuit arrangement as disclosed above or below in further detail. Specifically, the circuit arrangement may comprise at least one PCB. Thus, the test system may be an ICT system configured for performing an ICT. Further, the test system may be configured for assigning the UID to the property of the electronic device, e.g. the position, within a lookup table. The test system may be configured for sending out at least one general command to the circuit arrangement. The general command may be at least one of a general readout command and a general assign command. Other options may also be feasible. The test system may comprise at least one adapter, specifically at least one needle adapter. The adapter may be configured for being connected to the interface of the circuit arrangement. The adapter may further be configured for contacting the electronic device, specifically at least one pin of the electronic device. For further definitions and embodiments regarding the test system reference may specifically also be made to the definitions and embodiments presented with respect to the method for assigning an address to the electronic device.

In a further aspect, a use of at least one of the presented method, the electronic device, the circuit arrangement and the test system is presented. The purpose of use is an automotive application. In other words, the method and/or the electronic device and/or the circuit arrangement and/or the test system may specifically be used for an automotive application. Other uses may of course also be feasible as the skilled person will immediately recognize. Specifically, the method is a method according to any one of the embodiments referring to a method as disclosed above or below in further detail. The electronic device is an electronic device according to any one of the embodiments referring to an electronic device as disclosed above or below in further detail. The circuit arrangement is a circuit arrangement according to any one of the embodiments referring to a circuit arrangement as disclosed above or below in further detail. The test system is a test system according to any one of the embodiments referring to a test system as disclosed above or below in further detail.

The methods and devices presented herein have considerable advantages over the prior art as already indicated throughout the description. As said, they can help avoid assigning interfering addresses, specifically for electronic devices of the same type. This may lead to less susceptibility to errors, such as trying to address a specific electronic device with an address which has also been assigned to a further electronic device. This may eventually increase operational safety of a system using the electronic device or the circuit arrangement comprising the electronic device, such as an automotive system having considerable safety requirements. Consequently, the presented methods and devices may further help avoiding pre-defined address ranges, which may lead to greater flexibility. Further, by using a test system for assigning the addresses, which may anyway be used for testing the circuit arrangement before operation, no additional components may be required anymore for assigning the addresses. This may lead to less process complexity and eventually reduce cost. As outlined, the test system may take over several tasks during the assignment of the address. Thus, the test system may also take work off a controller of the circuit arrangement, specifically off a main microcontroller of the circuit arrangement. Further, as also outlined, a serial interface may be used, which may lead to a reduction of pins at the controller.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. In most cases, when referring to the respective feature or element, the expressions “at least one” or “one or more” are not repeated, notwithstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The disclosure may, as the skilled person will recognize, be performed by using alternative features. Similarly, features introduced by “in an embodiment of the disclosure” or similar expressions are intended to be optional features, without any restriction regarding alternative embodiments of the disclosure, without any restrictions regarding the scope of the disclosure and without any restriction regarding the possibility of combining the features introduced in such way with other optional or non-optional features of the disclosure.

Summarizing and without excluding further possible embodiments, the following embodiments may be envisaged:
Embodiment 1: A method for assigning an address to an electronic device, the method comprising:
   a) starting a test system for performing a test of a circuit arrangement comprising the electronic device;
   b) implementing a communication protocol between the circuit arrangement and the test system;
   c) reading out a predetermined unique identifier (UID) of the electronic device by using the test system;
   d) assigning the UID to at least one property of the electronic device within a lookup table, wherein the property is determined by using the test system; and
   e) assigning an address to the electronic device by using the lookup table.
Embodiment 2: The method according to the preceding Embodiment, wherein the property of the electronic device comprises a position of the electronic device in the circuit arrangement.
Embodiment 3: The method according to any one of the preceding Embodiments, wherein the property of the electronic device comprises a function of the electronic device within the circuit arrangement.
Embodiment 4: The method according to any one of the preceding Embodiments, wherein the property of the electronic device comprises a type number of the electronic device.
Embodiment 5: The method according to any one of the preceding Embodiments, wherein the circuit arrangement comprises a plurality of electronic devices, wherein the method comprises assigning an individual address to each electronic device of the circuit arrangement.
Embodiment 6: The method according to the preceding Embodiment, wherein at least two of the electronic devices are of the same type, wherein the at least two electronic devices of the same type are assigned different addresses.
Embodiment 7: The method according to any one of the preceding Embodiments, wherein the circuit arrangement comprises at least one printed circuit board (PCB), wherein the test of the circuit arrangement is an in-circuit testing (ICT), wherein the test system is an ICT system,
Embodiment 8: The method according to any one of the preceding Embodiments, wherein the electronic device is a part of a network and wherein the address is a network address.
Embodiment 9: The method according to any one of the preceding Embodiments, wherein the communication protocol determines at least a set of addresses.
Embodiment 10: The method according to the preceding Embodiment, wherein the set of addresses comprises at least a set of available addresses.
Embodiment 11: The method according to the preceding Embodiment, wherein step e) comprises assigning at least one of the UID and the property of the electronic device determined by using the test system to an available address.
Embodiment 12: The method according to any one of the preceding Embodiments, wherein the communication protocol determines at least a set of commands for communication between the circuit arrangement and the test system.
Embodiment 13: The method according to the preceding Embodiment, wherein the set of commands comprises at least one general command sent out to all electronic devices comprised by the circuit arrangement.
Embodiment 14: The method according to the preceding Embodiment, wherein the general command triggers at least one arbitration.
Embodiment 15: The method according to any one of the preceding Embodiments, wherein the readout of the UID in step c) is triggered by detecting a predetermined logical state of the electronic device with the test system.
Embodiment 16: The method according to the preceding Embodiment, wherein the logical state is determined in the communication protocol.
Embodiment 17: The method according to any one of the two preceding Embodiments, wherein the predetermined logical state comprises a predetermined voltage applied to at least one pin of the electronic device.
Embodiment 18: The method according to any one of the preceding Embodiments, wherein step c) comprises sending out a general readout command from the test system for sending the UID to the test system.
Embodiment 19: The method according to any one of the preceding Embodiments, wherein at least one of step d) and step e) is at least partially performed by using the test system.
Embodiment 20: The method according to any one of the preceding Embodiments, wherein step e) comprises sending out a general assign command from the test system, wherein the general assign command comprises the UID of the electronic device and the address assigned to the electronic device.
Embodiment 21: The method according to the preceding Embodiment, wherein step e) comprises acknowledging the assigned address by a handshake between the electronic device and the test system.
Embodiment 22: The method according to any one of the preceding Embodiments, wherein at least one of step d) and step e) is at least partially performed by using a controller, specifically a main microcontroller of the circuit arrangement.
Embodiment 23: The method according to the preceding Embodiment, wherein the lookup table is provided to the controller for assigning the address to the electronic device.
Embodiment 24: The method according to any one of the two preceding Embodiments, wherein step e) comprises sending out a general assign command from the controller, wherein the general assign command comprises the UID of the electronic device and the address assigned to the electronic device.
Embodiment 25: The method according to any one of the three preceding Embodiments, wherein step e) comprises acknowledging the assigned address by a handshake between the electronic device and the controller.
Embodiment 26: The method according to any one of the preceding Embodiments, wherein at least one of step d) and step e) is performed at an initial power-on of the circuit arrangement.
Embodiment 27: The method according to any one of the preceding Embodiments, wherein the UID is programmed on a non-volatile memory of the electronic device.
Embodiment 28: The method according to any one of the preceding Embodiments, wherein the UID is derived from an assigned chip identifier (chip ID) by using a predetermined algorithm.
Embodiment 29: The method according to any one of the preceding Embodiments, wherein step a) comprises connecting the test system with an interface of the circuit arrangement by using an adapter of the test system, specifically a needle adapter of the test system.
Embodiment 30: The method according to the preceding Embodiment, wherein step a) further comprises contacting a pin of the electronic device by using the adapter, specifically the needle adapter.
Embodiment 31: The method according to any one of the preceding Embodiments, wherein the method is at least partially computer-implemented.
Embodiment 32: An electronic device having an address assigned by using at least the following steps:
   a) starting a test system for performing a test of a circuit arrangement comprising the electronic device;
   b) implementing a communication protocol between the circuit arrangement and the test system;
   c) reading out a predetermined unique identifier (UID) of the electronic device by using the test system;
   d) assigning the UID to at least one property of the electronic device within a lookup table, wherein the property is determined by using the test system; and
   a) assigning an address to the electronic device by using the lookup table.
Embodiment 33: The electronic device according to the preceding Embodiment, wherein the address is assigned by using a method according to any one of the preceding method Embodiments.
Embodiment 34: The electronic device according to any one of the preceding Embodiments referring to an electronic device, wherein the electronic device comprises at least one pin configured for being contacted by an adapter of the test system, specifically by a needle adapter of the test system.
Embodiment 35: The electronic device according to any one of the preceding Embodiments referring to an electronic device, wherein the electronic device is network compatible.
Embodiment 36: The electronic device according to any one of the preceding Embodiments referring to an electronic device, wherein the electronic device is a semiconductor device.
Embodiment 37: The electronic device according to any one of the preceding Embodiments referring to an electronic device, wherein the electronic device comprises at least one electronic circuit, specifically at least one integrated circuit.
Embodiment 38: A circuit arrangement comprising at least one electronic device and at least one interface, wherein the electronic device has an address assigned by using at least the following steps:
   a) starting a test system for performing a test of a circuit arrangement comprising the electronic device;
   b) implementing a communication protocol between the circuit arrangement and the test system;
   c) reading out a predetermined unique identifier (UID) of the electronic device by using the test system;
   d) assigning the UID to at least one property of the electronic device within a lookup table, wherein the property is determined by using the test system; and
   a) assigning an address to the electronic device by using the lookup table.
Embodiment 39: The circuit arrangement according to the preceding Embodiment, wherein the address is assigned by using a method according to any one of the preceding method Embodiments.
Embodiment 40: The circuit arrangement according to any one of the preceding Embodiments referring to a circuit arrangement, wherein the electronic device is an electronic device according to any one of the preceding Embodiments referring to an electronic device.
Embodiment 41: The circuit arrangement according to any one of the preceding Embodiments referring to a circuit arrangement, wherein the circuit arrangement comprises at least one printed circuit board (PCB).
Embodiment 42: The circuit arrangement according to any one of the preceding Embodiments referring to a circuit arrangement, wherein the interface is a serial interface.
Embodiment 43: The circuit arrangement according to any one of the preceding Embodiments referring to a circuit arrangement, wherein the interface comprises at least one bus, specifically at least one serial bus.
Embodiment 44: The circuit arrangement according to the preceding Embodiment, wherein the bus comprises at least one signal line, specifically a data line.
Embodiment 45: The circuit arrangement according to any one of the preceding two Embodiments, wherein the bus comprises a clock line and a data line.
Embodiment 46: The circuit arrangement according to any one of the preceding three Embodiments, wherein the bus is an Inter-Integrated Circuit (I²C).
Embodiment 47: The circuit arrangement according to any one of the preceding Embodiments referring to a circuit arrangement, wherein the interface is configured for being connected to an adapter of the test system, specifically to a needle adapter.
Embodiment 48: The circuit arrangement according to any one of the preceding Embodiments referring to a circuit arrangement, wherein the electronic device is connected to the interface of the circuit arrangement.
Embodiment 49: The circuit arrangement according to any one of the preceding Embodiments referring to a circuit arrangement, wherein the electronic device comprises at least one pin, wherein the pin is a part of the interface of the circuit arrangement.
Embodiment 50: The circuit arrangement according to any one of the preceding Embodiments referring to a circuit arrangement, wherein the circuit arrangement comprises at least one controller, specifically a main microcontroller.
Embodiment 51: The circuit arrangement according to the preceding Embodiment, wherein the controller is connected to the interface of the circuit arrangement.
Embodiment 52: The circuit arrangement according to any one of the two preceding Embodiments, wherein the controller is configured for assigning the address to the electronic device by using the lookup table.
Embodiment 53: The circuit arrangement according to any one of the three preceding Embodiments, wherein the controller is configured for sending out a general assign command to the at least one electronic device of the circuit arrangement.
Embodiment 54: A test system configured for performing a test of at least one circuit arrangement, wherein the circuit arrangement comprises at least one electronic device and at least one interface, wherein the test system is further configured for reading out a predetermined unique identifier (UID) of the electronic device, wherein the test system is further configured for determining at least one property of the electronic device.
Embodiment 55: The test system according to the preceding Embodiment, wherein the property is selected from the group consisting of: a position of the electronic device in the circuit arrangement; a function of the electronic device within the circuit arrangement; a type number of the electronic device.
Embodiment 56: The test system according to any one of the preceding Embodiments referring to a test system, wherein the electronic device is an electronic device according to any one of the preceding claims referring to an electronic device.
Embodiment 57: The test system according to any one of the preceding Embodiments referring to a test system, wherein the circuit arrangement is a circuit arrangement according to any one of the preceding claims referring to a circuit arrangement.
Embodiment 58: The test system according to any one of the preceding Embodiments, wherein the circuit arrangement comprises at least one printed circuit board (PCB), wherein the test system is an in-circuit testing (ICT) system configured for performing an ICT.
Embodiment 59: The test system according to any one of the preceding Embodiments referring to a test system, wherein the test system is configured for assigning the UID to the property of the electronic device within a lookup table.
Embodiment 60: The test system according to the preceding Embodiment, wherein the test system is further configured for assigning an address to the electronic device by using the lookup table.
Embodiment 61: The test system according to any one of the preceding Embodiments referring to a test system, wherein the test system is configured for sending out at least one general command, specifically at least one of a general readout command and a general assign command, to the circuit arrangement.
Embodiment 62: The test system according to any one of the preceding Embodiments referring to a test system, wherein the test system comprises at least one adapter, specifically at least one needle adapter.
Embodiment 63: The test system according to the preceding Embodiment, wherein the adapter is configured for being connected to the interface of the circuit arrangement.
Embodiment 64: The test system according to any one of the two preceding Embodiments, wherein the adapter is configured for contacting the electronic device, specifically at least one pin of the electronic device.
Embodiment 65: A use of the at least one of a method according to any one of the preceding method Embodiments, an electronic device according to any one of the preceding Embodiments referring to an electronic device, a circuit arrangement according to any one of the preceding Embodiments referring to a circuit arrangement and a test system according to any one of the preceding Embodiments referring to a test system, wherein the purpose of use is an automotive application.

Further optional features and embodiments will be disclosed in more detail in the subsequent description of embodiments, preferably in conjunction with the dependent embodiments. Therein, the respective optional features may be realized in an isolated fashion as well as in any arbitrary feasible combination, as the skilled person will realize. The scope of the disclosure is not restricted by the preferred embodiments. The embodiments are schematically depicted in the Figures. Therein, identical reference numbers in these Figures refer to identical or functionally comparable elements.

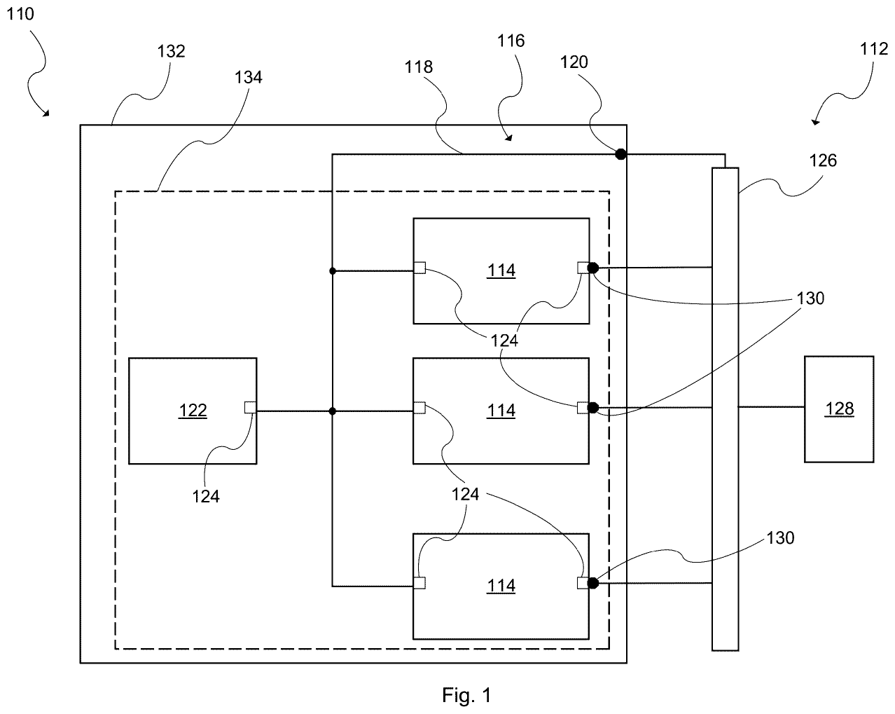

FIG. 1 illustrates an exemplary embodiment of a circuit arrangement 110 in interaction with a test system 112 in a schematic fashion. The circuit arrangement 110 comprises at least one electronic device 114, e.g. three electronic devices 114 as shown in FIG. 1. Another number may of course also be feasible. In principle, the circuit arrangement 110 may also comprise only one electronic device 114. The electronic device 114 may be semiconductor device. The electronic device 114 may comprise an electronic circuit, specifically an integrated circuit. As shown in FIG. 1, the circuit arrangement 110 may specifically comprise a plurality of electronic devices 114. The method for assigning an address to the electronic devices 114 may then specifically comprise assigning an individual address to each electronic device 114 of the circuit arrangement 110. Specifically, at least two of the electronic devices 114 may be of the same type. As an example, two of the three electronic devices 114 shown in FIG. 1 may be of the same type or in other words identical in design. In such case, the at least two electronic devices 114 of the same type may specifically be assigned different addresses. Thus, during operation of the circuit arrangement 110 later on, all electronic devices 114 may be individually addressable and distinguishable. This may result in a faultless operation of the circuit arrangement 110, such as when used in an automotive application for instance.

Besides the electronic devices 114, the circuit arrangement 110 further comprises at least one interface 116. The interface 116 may specifically be a serial interface. The interface 116 may comprise at least one bus 118. The bus 118 may specifically be a serial bus. The bus 118 may comprise at least one signal line, specifically a data line. The bus 118 may further comprise a clock line. Specifically, the bus 118 may be an Inter-Integrated Circuit (I²C). The interface 116 may be configured for being connected to the test system 112 for data transfer. Thus, the interface 116 may comprise at least one pin 120, which can be contacted from outside of the circuit arrangement 110. As a result, the interface 116 may be configured for connecting the circuit arrangement 110 to at least one external device such as the test system 112. Further, the interface 116 may be configured for interconnecting internal devices of the circuit arrangement 110.

The circuit arrangement 110 may further comprise at least one controller 122. The controller 122 may specifically be a microcontroller, more specifically a main microcontroller of the circuit arrangement. The controller 122 may be connected to the interface 116. The electronic devices 114 may also be connected to the interface 116. The controller 122 and/or the electronic devices 114 or at least one of them may comprise at least one input/output module 124. The input/output module 124 may itself be a device interface and may specifically also be a serial interface. The input/output module 124 may enable a device to receive information from further devices via the interface 116 and/or send out information to further devices via the interface 116. Thus, the electronic devices 114 and the controller 122 may be interconnected via the interface 116, specifically via the bus 118. As a result, the controller 122 may be configured for controlling the electronic devices 114, such as sending data packages to the electronic devices 114 and/or receiving data packages from the electronic devices 114. Specifically, the controller 122 may be configured for sending commands to the electronic devices 114. The controller 122 may be configured for sending out general commands to all electronic devices 114 of the circuit arrangement 110. However, as indicated, also external devices such as the test system 112 may be configured to do so via the pin 120.

The test system 112 may comprise an adapter 126. The adapter 126 may specifically be a needle adapter. The test system 112 may further comprise at least one evaluation module 128. The evaluation module 128 may be configured for evaluating or analyzing signals received by the adapter 126. The evaluation module 128 may be configured for at least partially controlling the adapter 128. The evaluation module 128 may comprise at least one processor or at least one microprocessor. Specifically, the evaluation module 128 may comprise at least one central processing unit or at least one field-programmable gate array. The evaluation module 128 may be connected to the adapter 126 and optionally also to further entities not shown in FIG. 1. As an example, the evaluation module 128 may be part of a cloud. The adapter 126 may be configured for being connected to the interface 116, such as by contacting the pin 120 with a needle. In other words, the interface 116 may be configured for being connected to the adapter 126 of for being contacted by the adapter 126.

Further, the electronic devices 114 may also be configured for being connected to the adapter 126 or for being contacted by the adapter 126. Thus, the electronic devices 114 may also each comprise a pin 130. The pins 130 may be configured for being contacted by external devices, such as specifically by the test system 112. Thus, the pins 130 may enable a signal transfer to an outside of the circuit arrangement 110. In that sense, the pins 130 may also a part of the interface 116 of the circuit arrangement 110. The adapter 126 may also be configured for contacting the pins 130. Thus, the adapter 126 may be configured for contacting the electronic devices 114 of for being connected to the electronic devices 114 via the pins 130.

The circuit arrangement 110 may comprise a printed circuit board (PCB) 132. The electronic device 114, the controller 122 and the interface 116 may be arranged on the PCB 132. Thus, the test system 112 may specifically be an in-circuit testing (ICT) system configured for performing an ICT. Thus, a test of the circuit arrangement 110 may specifically be an ICT. The controller 122 and the electronic devices 114 may further form a network 134 on the PCB 132. Thus, the electronic devices 114 may be a part of the network 134 and the address assigned to them may be a network address. The electronic devices 114 may be network compatible.

As said, the electronic devices 114 may specifically comprise input/output modules 124 enabling them to receive information from further devices via the interface 116 and send out information to further devices via the interface 116. In principle, also entities outside of the circuit arrangement 110 may be part of the network 134. Such entities may also communicate with the circuit arrangement 110 and its components by using the interface 116 and specifically the pin 120 for instance.

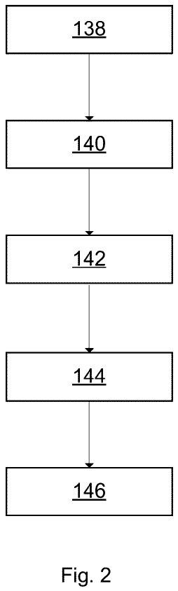

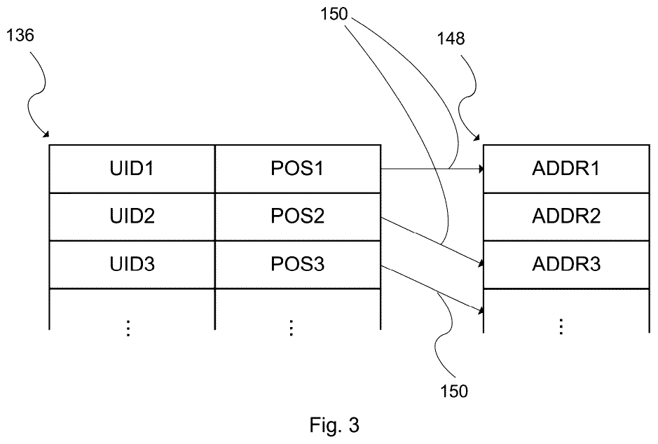

FIG. 2 illustrates a flow chart of an exemplary embodiment of a method for assigning an address to the electronic device 114. FIG. 3 illustrates a diagram of an exemplary embodiment of a specific procedure for the address assignment including using a lookup table 136. Thus, FIG. 2 and FIG. 3 will be described in conjunction in the following. The method comprises:
a) (denoted with reference numeral 138) starting the test system 112 for performing a test of the circuit arrangement 110 comprising the electronic device 114;
b) (denoted with reference numeral 140) implementing a communication protocol between the circuit arrangement 110 and the test system 112;
c) (denoted with reference numeral 142) reading out a predetermined unique identifier (UID) of the electronic device 114 by using the test system 112;
d) (denoted with reference numeral 144) assigning the UID to at least one property of the electronic device 114 within the lookup table 136, wherein the property is determined by using the test system 112; and
e) (denoted with reference numeral 146) assigning an address to the electronic device 114 by using the lookup table 136.

Thus, the electronic device 114, as e.g. comprised by the circuit arrangement 110, eventually has an address assigned by using at least the abovementioned steps. The presented method steps may be performed in the indicated order. It shall be noted, however, that a different order may also be possible. The method may comprise further method steps which are not listed. Further, one or more of the method steps may be performed once or repeatedly. Further, two or more of the method steps may be performed simultaneously or in a timely overlapping fashion. Specifically, steps a) to c) may be performed during a test of the circuit arrangement 110. Step d) and/or step e) may also be performed during the test. Thus, at least one of step d) and step e) may at least partially be performed by using the test system 112. Further, at least one of step d) and step e) may be performed at an initial power-on of the circuit arrangement 110 and/or by using the controller 122. The method may at least partially be computer-implemented.

The UID may be programmed on a non-volatile memory of the electronic device 114 and/or may be derived from a chip identifier (chip ID) assigned by a manufacturer of the electronic device 114 by using a predetermined algorithm. The property of the electronic device 114, as mentioned in step d), may specifically comprise a position of the electronic device 114 in the circuit arrangement 110. Thus, the lookup table 136 in FIG. 3 shows a UID being assigned to a position, such as UID1 to POS1, UID2 to POS2, UID3 to POS3 etc.. Additionally or alternatively, the property may however also comprise a function of the electronic device 114 within the circuit arrangement 110 and/or a type number of the electronic device 114. Other options may also be feasible. The position of the electronic device 114 may directly be determined in the test of the circuit arrangement 110.

As an example and without limiting further options, the test system 112 may test the circuit arrangement 110, such as for determining whether the circuit arrangement works correctly or not. For such purpose, the adapter 126 may inter alia contact the pin 120. Thus, the test system 112 may be connected with the circuit arrangement 110, specifically with the interface 116 and more specifically with the bus 118. By contacting the pin 120 with the adapter 126, the test system 112 may be connected to the bus 118 in order to communicate with the electronic devices 114 and the controller 122. The communication protocol implemented between the circuit arrangement 110 and the test system 112 may determine a set of commands for communication. The set of commands may comprise at least one general command. Thus, the test system 112 may send a general readout command to all electronic devices 114 of the circuit arrangement 110 asking them for their respective UIDs. For this purpose, the controller 122 may be switched off and/or disconnected from the bus 118, such that it does not interfere. The general readout command may trigger at least one arbitration. In the following, the electronic devices 114 may send their respective UIDs to the test system via the bus 118.

Further, the adapter 126 may contact the pins 130 during the test of the circuit arrangement 110. The readout of the UID may then be triggered by detecting a predetermined logical state of the electronic devices 114 with the test system 112. The logical state may be determined in the communication protocol. Specifically, the logical state may be a predetermined voltage applied to the pins 130. The test system 112 may detect the predetermined voltage and may thus know that the corresponding electronic device 114 has a UID which can be read out. As an example, the predetermined voltage may cause an electric current going from the pin 130 to the adapter 126 which can be detected by the test system 112. Thus, when performing the test of the circuit arrangement 110, the test system 112 may know by contacting the pins 130 which electronic devices 114 have an UID to be read out.

The test system 112 may further know a position of the electronic devices 114 when performing the test of the circuit arrangement 110, since the test system 112 typically has to spatially contact the electronic devices 114 during the test. Thus, the test system 112 may assign the read UID of the electronic device 114 to its position in the circuit arrangement 110 within the lookup table 136. The test system 112 may also derive further properties of the electronic device 114 from its position such as its function and/or its type number. When considering an ICT of the PCB 132, such properties can for instance be derived by considering given mounting options on the PCB 132. Thus, the test system is configured for performing a test of the circuit arrangement 110, for reading out a UID of the electronic device 114 and for further determining at least one property of the electronic device 114. The property may specifically be at least one of a position of the electronic device 114, a function of the electronic device 114 and a type number of the electronic device 114. Other options may also be feasible. The test system 112 may further be configured for assigning the UID to the property within the lookup table 136.

Further, the test system 112 may be configured for assigning an address to the electronic device 114 by using the lookup table 136. For such purpose, the test system 112 may send out a general assign command to the electronic devices 114 by using the bus 118. Again, the controller 122 may be switched off and/or disconnected from the bus 118, such that it does not interfere. The general assign command may comprise the UID of the electronic device 114 and the address assigned to the electronic device 114. Each electronic device 114 may recognize its own UID and accept the address sent along with it, which may eventually be acknowledged by a handshake between the electronic device 114 and the test system 112.

Alternatively, the generated lookup table 136 may be provided to the controller 122. For instance at an initial power-on of the circuit arrangement 110, the controller 122 may then send out a general assign command accordingly. In this case, the test system 112 may be disconnected from the bus 118 or switched off, such that it does not interfere. As before, the general assign command may comprise the UID of the electronic device 114 and the address assigned to the electronic device 114. Each electronic device 114 may recognize its own UID and accept the address sent along with it, which may eventually be acknowledged by a handshake between the electronic device 114 and the controller 122. Thus, the controller 122 may also be configured for sending out a general assign command and for assigning the address to the electronic device 114 by using the lookup table 136.

The address may be determined in the communication protocol. The communication protocol may generally determine a set of addresses. The set of addresses may comprise available addresses and already occupied addresses. As an example, the set of addresses may be in the form of an address list 148 having addresses ADDR1, ADDR2, ADDR3 etc. as shown in FIG. 3. As an example, ADDR1 may be available, ADDR2 may be occupied and ADDR3 may be available again. Thus, the set of addresses comprises a set of available addresses, in this case ADDR1 and ADDR3. When assigning an address to the electronic device 114 by using the lookup table 136, the respective UID mapped to a property of the electronic device 114, e.g. a position of the electronic device 114, may specifically be assigned to an available address as indicated by arrows 150. Thus, in the given example, UID1 and POS1 may be assigned to ADDR1. ADDR2 may as said be occupied and may therefore not be used for an assignment. Thus, UID2 and POS2 may then be assigned to the next available address. ADDR3 may be available again. Thus, UID2 and POS2 may then be assigned to ADDR3. Other schemes may also be feasible.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the disclosure and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the disclosure, as well as specific examples thereof, are intended to encompass equivalents thereof.

1. A method for assigning an address to an electronic device, the method comprising:
starting a test system for performing a test of a circuit arrangement comprising the electronic device;
implementing a communication protocol between the circuit arrangement and the test system;
reading out a predetermined unique identifier (UID) of the electronic device by using the test system;
assigning the UID to at least one property of the electronic device within a lookup table, wherein the property is determined by using the test system; and
assigning an address to the electronic device by using the lookup table.

2. The method according to claim 1, wherein the property of the electronic device comprises a position of the electronic device in the circuit arrangement.

3. The method according to claim 1, wherein the circuit arrangement comprises a plurality of electronic devices, wherein the method comprises assigning an individual address to each of the plurality of electronic devices of the circuit arrangement .

4. The method according to claim 3, wherein at least two of the plurality of electronic devices are of the same type, wherein the at least two electronic devices of the same type are assigned different addresses.

5. The method according to claim 1, wherein the circuit arrangement comprises at least one printed circuit board (PCB), wherein the test of the circuit arrangement is an in-circuit testing (ICT), wherein the test system is an ICT system.

6. The method according to claim 1, wherein the electronic device is a part of a network and wherein the address is a network address.

7. The method according to claim 1, wherein the communication protocol determines at least a set of addresses, wherein the set of addresses comprises at least a set of available addresses, wherein assigning the address comprises assigning at least one of the UID and the property of the electronic device determined by using the test system to an available address.

8. The method according to claim 1, wherein the communication protocol determines at least a set of commands for communication between the circuit arrangement and the test system, wherein the set of commands comprises at least one general command sent out to all electronic devices comprised by the circuit arrangement.

9. The method according to claim 1, wherein the readout of the UID in is triggered by detecting a predetermined logical state of the electronic device with the test system, wherein the logical state is determined in the communication protocol.

10. The method according to claim 1, wherein the predetermined logical state comprises a predetermined voltage applied to at least one pin of the electronic device.

11. The method according to claim 1, wherein at least one of assigning the UID to at least one property of the electronic device within a lookup table and assigning an address to the electronic device by using the lookup table is at least partially performed by using the test system.

12. The method according to claim 1, wherein at least one of assigning the UID to at least one property of the electronic device within a lookup table and assigning an address to the electronic device by using the lookup table is at least partially performed by using a controller.

13. The method according to claim 1, wherein at least one of assigning the UID to at least one property of the electronic device within a lookup table and assigning an address to the electronic device by using the lookup table is performed at an initial power-on of the circuit arrangement.

14. The method according to claim 1, wherein starting the test system comprises connecting the test system with an interface of the circuit arrangement by using an adapter of the test system, wherein starting the test system further comprises contacting a pin of the electronic device by using the adapter.

15. An electronic device having an address assigned by using at least the following steps:
starting a test system for performing a test of a circuit arrangement comprising the electronic device;
implementing a communication protocol between the circuit arrangement and the test system;
reading out a predetermined unique identifier (UID) of the electronic device by using the test system;
assigning the UID to at least one property of the electronic device within a lookup table, wherein the property is determined by using the test system; and
assigning an address to the electronic device by using the lookup table.

16. A circuit arrangement comprising at least one electronic device and at least one interface, wherein the electronic device has an address assigned by using at least the following steps:
starting a test system for performing a test of a circuit arrangement comprising the electronic device;
implementing a communication protocol between the circuit arrangement and the test system;
reading out a predetermined unique identifier (UID) of the electronic device by using the test system;
assigning the UID to at least one property of the electronic device within a lookup table, wherein the property is determined by using the test system; and
assigning an address to the electronic device by using the lookup table.

17. The circuit arrangement according to claim 16 the preceding claim, wherein the interface is a serial interface.

18. The circuit arrangement according to claim 16, wherein the interface comprises at least one bus, wherein the bus is an Inter-Integrated Circuit (I²C).

19. A test system configured for performing a test of at least one circuit arrangement, wherein the circuit arrangement comprises at least one electronic device and at least one interface, wherein the test system is further configured for reading out a predetermined unique identifier (UID) of the electronic device, wherein the test system is further configured for determining at least one property of the electronic device.

20. The method of claim 1, wherein the method is performed in an automotive application.
